(19) United States
(12) Patent Application Publication
(10) Pub. No.: US 2021/0254840 A1
(43) Pub. Date: Aug. 19, 2021

(54) COVERING, FUNCTIONAL ELEMENT FOR A COVERING, AND METHOD FOR PRODUCING A COVERING

(71) Applicant: EliTilE AG, Saarbrücken (DE)

(72) Inventors: Rolf Wilmes, Eppelborn (DE); Ralf Thull, Hespe (DE)

(73) Assignee: EliTilE AG, Saarbrücken (DE)

(21) Appl. No.: 17/269,875

(22) PCT Filed: Aug. 22, 2019
(86) PCT No.: PCT/EP2019/072507

§ 371 Date: Feb. 19, 2021

(30) Foreign Application Priority Data
Aug. 22, 2018 (DE) 202018003862.8
Jan. 21, 2019 (DE) 202019000250.2

(51) Int. Cl. F24D 19/02; E04F 15/024; E04F 15/10; E04C 2/52; F24D 13/02; F24D 3/14; F24D 19/10; H05B 3/06

(52) U.S. Cl. CPC F24D 19/022; E04F 15/02405; E04F 15/107; E04C 2/525; F24D 13/024; F24D 3/141; H05B 2203/016; F24D 19/1009; H05B 3/06; F24D 2220/042; F24D 2220/046; F24D 2220/006; H05B 2203/026; F24D 19/1096

(57) ABSTRACT

In order to control the temperature of a covering, the process of laying a heating line under the individual covering elements is known. However, this leads to various disadvantages. A functional body for a covering is provided which can be temperature-controlled, has an increased stability and is inexpensive to produce. This is achieved in that a bottom side of the functional body can be deposited on a substrate and a top side thereof can be joined together with the covering. The covering may for example be a floor covering, but may also be a wall covering or a cover element, in particular a tile, a glazed tile, a panel or the like for applications for indoor and outdoor regions. A temperature-control means is arranged on or in the top side of the functional body.

### CROSS REFERENCE TO RELATED APPLICATIONS

This application is the US National Phase of and claims the benefit of and priority on International Application No. PCT/EP2019/072507 having a filing date of 22 Aug. 2019, which claims priority on and the benefit of German Patent Application No. 20 2018 003 862.8 having a filing date of 22 Aug. 2018 and German Patent Application No. 20 2019 000 250.2 having a filing date of 21 Jan. 2019.

### BACKGROUND OF THE INVENTION

### Technical Field

The invention relates to a functional body for a covering, in particular a floor covering or a cover element, such as, for example, a tile, a glazed tile or a panel, having a bottom side which can be deposited on a substrate and a top side which can be joined together with the covering. The invention furthermore relates to a covering, in particular a floor covering or a wall covering or a cover element, such as, for example, a tile, a glazed tile or a panel, a fiber-cement plate, a gypsum plasterboard or a decoupling membrane, one side of which can be joined together with a functional body. The invention also relates to a method for producing a covering with a functional body wherein a flowable adhesive is applied to a structured functional body, in which a temperature-control means is integrated, and the covering is deposited on said functional body which has been provided with adhesive.

### Prior Art

In order to control the temperature of a covering, preferably a floor covering or a wall covering or a cover element, in particular in order to heat same, the process of laying a heating line under the individual covering elements is known. It is thus possible, for example, for public spaces and sidewalks, but also private terrace areas, to be heated, which can be advantageous particularly in the case of cold weather. The aforementioned areas can thus also be kept free of ice in the winter. In order to heat the coverings, use is usually made of electrical lines or pipes which conduct a heatable heating means. Said lines are arranged under the total regions of the tiles in such a way that the area is heated homogeneously. To this end, the lines are typically laid on grit or on lean concrete or the like, on which the covering is also laid. In these known methods, the heating line is thus initially integrated in a layer which forms the foundation and then the covering is laid on said line or on said layer. The aforementioned coverings may comprise both tiles, glazed tiles or else panels or other means for covering a floor or for cladding a wall or a ceiling.

A disadvantage of a heating line which is laid on or in the substrate is that when there is a defect in the line, such as, for example, a leak, said defect cannot be located and thus all of the tiles have to be lifted up for repair work.

A further disadvantage of known coverings, in particular floor coverings, is that said coverings are laid on raised floor supports and cannot be heated homogeneously over the entire area in this case. In addition, for the use of raised floor supports, only coverings having a great strength or thickness can be used. However, this leads, on the one hand, to increased costs and, on the other hand, to a poor thermal conductivity. Although relatively thin tiles have a better conductivity, on the other hand, the risk of the tiles breaking in the case of high loading increases.

A further disadvantage in the use of raised floor supports is that an intermediate space is formed between the covering and the substrate as a result of the supports. On account of said intermediate space, the temperature of tiles which are supported on raised floor supports cannot be controlled by means of the above-described method. If the heating lines were to be deposited on the substrate, the air between the tiles and the substrate acts in a thermally insulating manner, and therefore only a fraction of the released thermal energy is transferred to the tiles.

### BRIEF SUMMARY OF THE INVENTION

Against this background, the object of the present invention consists in providing a functional body, and also a covering, and a method for producing a covering which can be temperature-controlled in a simple and efficient manner and has an increased stability and can be produced in an inexpensive and flexible manner.

A functional body for achieving said object is a functional body for a covering, in particular a floor covering or a wall covering or for a cover element, such as, for example, a tile, a glazed tile or a panel, having a bottom side which can be deposited on a substrate and a top side which can be joined together with the covering, characterized in that a temperature-control means can be arranged on or in the top side. Accordingly, provision is made for a bottom side of the functional body to be able to be deposited on a substrate and a top side thereof to be able to be joined together with the covering. The covering may for example be a floor covering, but may also be a wall covering or a cover element, in particular a tile, a glazed tile, a panel or the like for applications for indoor and outdoor regions. A temperature-control means is arranged on or in the top side of the functional body. The means for controlling the temperature, preferably for heating or cooling, is thus enclosed in a sandwich-like manner between the covering and the functional body, and therefore the heat energy can be transferred to the covering efficiently and at least virtually without heat loss.

Advantageously, a size and a shape of a base area of the functional body at least virtually corresponds to a size and/or a shape of a base area of the covering, or a size of the base area of the functional body corresponds to a fraction of the size of the base area of the covering. It is thus possible for the functional body to be arranged at least virtually congruently under the covering. By joining together a plurality of coverings to comprehensively cover a substrate or a wall, it is possible to control the temperature of all of the individual coverings in an efficient and complete manner. As a result of the fact that all of the coverings are assigned a dedicated functional body, the size of which at least virtually corresponds with the size and shape of the covering, the formation of cold sinks is avoided. As an alternative, however, it is also conceivable according to the invention for a covering to be assigned a plurality of functional bodies, the base areas of which, collectively, are at least virtually identical to the base area of the covering. The arrangement of a plurality of relatively small functional bodies under the covering makes it possible to customize the control or properties of the covering according to the invention. It is also conceivable for the size and/or shape of the functional bodies to be adapted to the covering. In particular for peripheral regions of a terrace, for example, or in the case of a particular covering pattern, the shape and size of the functional bodies can be adapted in an individual and situation-specific manner.

Provision can also be made according to the invention for the functional body to be composed of a heat-insulating material, such as, for example, a foam, polystyrene, a plastic, wood fibers, stone wool, glass wool or mineral wool, vacuum insulation panels or the like. As a result of the selection of such a heat-insulating material, the thermal energy of the temperature-control means is virtually completely transferred to the covering. On account of the poor thermal conductivity of the aforementioned substances, only a small amount of thermal energy is absorbed by the functional body. In addition, the aforementioned materials can be machined, or altered in terms of shape, in a very good and simple manner.

Provision can also be made according to the invention for an outer border on the top side of the functional body to have a sealing means, in particular a sealing surface or a sealing lip which is preferably self-adhesive and can be brought together with the covering. Said sealing means has the result that the functional body can be connected to the covering in a particularly advantageous manner. When the functional body is joined together with the covering, an adhesive is applied to the functional body. The sealing means are provided so that the adhesive does not escape beyond the border of the functional body during the attachment of the covering to the functional body. Said sealing means prevent the adhesive from going beyond the border of the functional body or of the covering. Provision can be made for a protective film to be provided on the self-adhesive border so that said, in particular self-adhesive, sealing means does not get dirty or lose its potential adhesive action already prior to the joining together of the covering and the functional body.

In a further advantageous exemplary embodiment of the present invention, provision can be made for reinforcing elements and/or reinforcement elements composed of plastic, metal or the like to be integrated, preferably incorporated or molded, in the functional body, wherein the reinforcing elements and/or reinforcement elements are arranged in corner regions and/or side regions and/or in a cross-like manner over the total area of the functional body and/or areally over the functional body. Said reinforcing elements or reinforcement elements confer increased stability on the functional body. This increased stability allows the use of particularly thin tiles. Thin tiles have the advantage, inter alia, that their temperature can be controlled more effectively and that they can be laid more easily on account of the lower weight. As a result of the reinforcing elements or reinforcement elements of the functional body, a risk of breakage, which usually exists in the case of thin tiles, is reduced.

Provision can particularly preferably be made for at least one region, preferably an edge region and/or a corner region, in particular all four corner regions of a rectangular functional body, of the functional body to have a reinforcement, wherein the reinforcement is a, in particular moldable, material such as, for example, resin, mortar or the like, and said reinforcement extends over a total height of the functional body in the functional body. In the case of a rectangular functional body, provision is made for all four corner regions to have such a reinforcement. For said reinforcement, the corresponding regions in the functional body are carved out and then filled again with the aforementioned flowable materials, and therefore the functional body has an increased compressive strength in said regions. With said reinforcements or reinforced regions, the functional body can be set down on a raised floor support. In the case of rectangular functional bodies, a raised floor support can be assigned to each corner region or to each reinforcement. In the case of an areal floor coverage comprising a plurality of coverings, a plurality of functional bodies or a plurality of reinforced regions of the functional body can be assigned to each raised floor support. This local reinforcement of the functional bodies makes it possible for the insulating material to extend over the total base area of the covering. As a result, it is also possible for the temperature-control means to be assigned to the total base area of the covering. The reinforcement of the functional body thus has the result that the temperature of the entire covering can be controlled homogeneously, specifically without, for example, corner regions being excluded from the temperature control. Equally, it is conceivable for regions between the edges or peripheral regions of the functional body, in particular central regions, to also have a reinforcement. Said regions, which are likewise configured like the corner regions discussed above, can also be assigned raised floor supports. Particularly in the case of relatively large and/or relatively thin tile coverings, a central raised floor support may be advantageous.

In addition, provision can be made for the functional body to be able to be set down with a respective reinforcement on a raised floor support, wherein a functional body can be set down with four regions, which have a reinforcement, on four raised floor supports and/or can be set down with a reinforcement of a central region of the functional body on at least one raised floor support.

Provision is in particular made for the functional body to have a height of 10 mm to 50 mm or 20 mm to 40 mm, in particular of 30 mm. This dimensioning leads, on the one hand, to sufficient heat insulation and, on the other hand, it provides the reinforcement with a sufficient thickness or strength to absorb or compensate for loads on the covering.

The covering can be connected or adhesively bonded to the top side of the functional body. To this end, a corresponding adhesive means is supplied to the top side of the functional body, said adhesive means possibly being distributed between the temperature-control means and forming an adhesive action with the covering. If the temperature-control means is integrated in the top side of the functional body, the connecting means areally covers the top side of the functional body and thus is in full-area contact with the covering.

In a further exemplary embodiment of the invention, provision can be made for the top side of the functional body to have at least one, in particular winding or meandering, channel or a honeycomb-like pattern or a profiling with a waffle structure in order to receive the temperature-control means, wherein the channel or the pattern extends over the entire top side. Said channels or patterns or profilings can be milled into the functional body. In the production of the functional body, it is also possible for a corresponding mold to already have said channels or patterns or profilings. During the adhesive bonding of the functional body to the covering, said channels or patterns or profilings are filled with the corresponding adhesive means, and therefore the temperature-control means is integrated therein. A build-up of heat in the functional body is avoided as a result of the filling of the cavities. In this case, it should be ensured that the adhesive means has a very good thermal conductivity.

Provision is preferably made for the temperature-control means to be a heating wire, a pipe for guiding a heating means or cooling means, or the like, which is arranged in the channel or the pattern. Said heating wire or the pipe can be assigned to the top side of the functional body in a winding or meandering manner or in some other manner. To this end, the heating wire or the pipe is arranged between the covering or the top side of the functional body in such a way that the covering can be heated at least largely homogeneously. To this end, two first ends of the heating wire or connections or valves of the pipe are conducted away or led away over a periphery of the functional body. Said two first ends or valves have means, such as, for example, plug-in connectors, clamps, clamping connections, solder connections, valves or the like, in order to be connected or coupled to other wires or pipes of adjacent coverings. The floor covering can thus be heated by way of said two ends. Either said two first ends of a floor covering are connected directly to a corresponding energy source or liquid source or a multiplicity of coverings connected in series or in parallel are connected to a source for generating electrical energy or to a pump for conducting a liquid. By way of corresponding control, the covering or the multiplicity of coverings can thus be heated by application of thermal energy to the heating wires or the pipes. This actuation of the energy source can, for example, be effected directly via a switch or can be remote-controlled, such as, for example, by way of an app on a cell phone.

Provision can also be made for the temperature-control means, in particular the heating wire, to be enclosed between two lattice structures composed of, preferably, metal or plastic. In this case, the two lattice structures, the shape of which at least largely corresponds to the shape of the functional body, can be coupled to one another by connecting elements. The, for example, meandering profile of the temperature-control means is obtained by way of the two joined-together lattice structures. It is thus possible for the covering together with the functional body and the lattice structures comprising the temperature-control means to form a kit, from which it is possible to assemble the temperature-controllable covering by supplying an adhesive means.

In the present invention, provision can also be made for the bottom side of the functional body to have at least one, in particular winding or meandering, channel or a honeycomb-like pattern in order to receive cables of the temperature-control means. In this way, it is in particular possible for connecting cables of the various temperature-control means to be stowed or laid under the functional bodies in an organized and secure manner. Said further channels or patterns on the bottom side of the functional body make it possible to form a compact element, namely the functional body, which has merely two connections via which said body can be coupled to further functional bodies. As a result of the joining together of the functional body and the covering, it is thus possible for any floor covering, wall covering and cover elements to be laid in a simple, flexible and rapid manner.

Provision can also be made for the bottom side of the functional body to have a symmetrical channel structure in order to receive cable portions or pipe portions of identical length, such that plug-in connections of adjacent functional bodies project to the same extent beyond the respective functional body. In the case of this channel structure, provision can be made for the functional body to be assigned a central recess, in which a temperature-control means or the like is arranged, for example. The channels which lead away from said centered recess each have an identical length with respect to the side edges or are of symmetrical construction. This symmetrical configuration of the channels with respect to all of the side edges makes it possible for the covering or the functional body to be laid on the substrate independently of direction, that is to say the covering or the functional body has no preferred orientation and can thus be used in a particularly flexible manner. The symmetrical construction of the channel structure makes it possible, in particular, for components having cables, said components being assigned to the bottom side, to be laid or used in a particularly flexible manner. Regardless of how the covering is laid, the same length of a cable portion is always available for producing a connection to a control unit or a line or a cable of an adjacent covering.

Furthermore, provision can be made for side regions of the functional body to have cutouts in order to receive the means, in particular plug-in connectors, clamps, crimp connections, solder connections, valves or the like, for connection of a plurality of heating wires or pipes of adjacent functional bodies. Said cutouts have precise dimensions such that the aforementioned means for connection of a plurality of heating wires or pipes can be stowed. In this case, said cutouts are assigned to the bottom side in such a way that the contact area of the top side of the functional body with the covering remains unaffected by said cutout. As a result, the optimal transfer of heat between the functional body or the temperature-control means and the covering is maintained.

Furthermore, provision can be made according to the invention for two second ends of the heating wire to be connected to one another, specifically preferably by a thermal element, an overheat protection means, a resistor, a temperature sensor, a bimetal switch or the like. It is also conceivable for each floor covering or each tile or each glazed tile to be assigned a further cable for obtaining readings from a sensor means, such as, for example, a thermometer or a humidity sensor. The ascertainment of the temperature or the humidity makes it possible for the temperature of the floor covering or of the tile to be controlled in a climate-dependent manner. Such control makes it possible to maximize the well-being of a person who is situated on the covering or is in a room whose walls are provided with the coverings or functional bodies according to the invention.

A further development of the present invention can consist in the means for controlling the temperature of the floor covering having at least one pipe for guiding a cooling means, wherein the ends of the at least one pipe have connecting means and/or valves for connecting the at least one pipe to further pipes, preferably further pipes of adjacent floor coverings. The individual pipes of adjacent floor coverings are provided with the cooled liquid by way of a pump. In order to cool the liquid, a corresponding device for cooling liquids is provided. As a result of the flowing of the cooling means along the bottom side of the floor covering or of the tile, heat energy is withdrawn from the floor covering, and therefore the top side of the floor covering is also cooled. This may be advantageous in particular in the case of a peripheral region of a swimming pool or designated areas in hot regions. As a result of the fact that the ends of a pipe of a floor covering have a valve, the individual floor coverings of an area having such floor coverings can be cooled individually. In addition, by way of targeted actuation of the valves, it is thus possible for example for a defective floor covering to be exchanged in a simple manner. To this end, the valves of a pipe of a covering are closed, in particular automatically, specifically without the temperature control of the rest of the coverings being influenced as a result. To this end, provision can be made for the defective covering or a bypass line to be excluded from the temperature control of the intended area. For this exemplary embodiment, provision is also made for the functional body to be able to be assigned a temperature sensor or a humidity sensor.

Provision can also be made according to the invention for the temperature for a covering with a temperature-control means (master) to be set by means of a control unit and functional bodies (slave) which are also coupled to the functional body or to the temperature-control means to adapt to said temperature. This master/slave control arrangement makes it possible to regulate the temperature of all of the coverings with a very low control effort. It is also conceivable for the temperature of individual coverings or of groups of coverings to be able to be controlled individually by way of the control unit. Provision can thus be made for the temperature of only individual coverings, which are arranged for example in a seating region of a terrace, to be controlled, whereas the temperature of other coverings is not controlled. Equally, it is possible for the temperature of entire groups or regions or areas of coverings to be collectively controlled. In this way, the temperature of a floor covering can be controlled in a particularly efficient and energy-saving manner. The control unit makes it possible for each individual covering or each individual functional body to be actuated separately and individually in targeted fashion.

Provision can also be made for the control unit to be connected to at least one sensor means which is integrated in the functional body and/or the covering, wherein the temperature of the functional body and/or of the covering can be controlled in dependence on a measurement value of the sensor means. Such a sensor means may for example be a temperature sensor, a moisture sensor or a pressure sensor. It is thus for example conceivable for a pressure sensor to be used to determine whether there is a chair or a person standing on a covering. It is then possible for the temperature of precisely said region or said floor covering to be controlled. In a further embodiment, provision can be made that, during the measurement of the humidification of the covering, said covering is heated in order to avoid the formation of ice in particular in the case of minus temperatures.

A further advantage of the present invention can consist in the means for controlling the temperature of the covering being operable with an electrical mains voltage. The operator can thus connect their heatable terrace to a, for example 230 V, home connection in a simple manner.

Provision can also be made for the functional body to be protected by a metal layer or a plastics layer or a shell, in particular a metal shell or a plastics shell. Said layer or shell can also have the effect that the infrared radiation emitted by the heating means is reflected back onto the covering.

Provision can also be made for the bottom side of the functional body to have a grid of projections, in particular drainage nubs. Provision can also be made for the functional bodies to be deposited directly on a substrate. The bottom side has such nubs or drainage nubs so that the functional bodies lie stably on said substrate and a sufficient exchange of moisture can nevertheless take place. By way of such nubs, a latching to the substrate can be effected. At the same time, there are still intermediate spaces through which moisture can escape.

In a further advantageous exemplary embodiment of the invention, provision can be made for further components to be able to be integrated in the functional body and/or in the covering, such as, for example, speakers, illuminants, power sockets, network sockets or the like, said components being able to be actuated, in particular individually or in groups, via corresponding lines beneath the covering. In this case, the lines can for example be coupled to the control unit, and therefore said lines can also be stowed in the channel structure under the functional bodies. In this way, the individual coverings, in particular floor or wall coverings, can be utilized to establish a light installation or a sound system.

A covering for achieving the object mentioned in the introduction is a covering, in particular a floor covering or a wall covering or a cover element, such as, for example, a tile, a glazed tile or a panel, a fiber-cement plate, a gypsum plasterboard or a decoupling membrane, one side of which can be joined together with a functional body. Accordingly, provision is made for a covering, in particular a floor covering or a wall covering or a cover element, such as, for example, a tile, a glazed tile or a panel, to be able to be joined together with a functional body as disclosed herein. By way of a multiplicity of coverings which can be arranged alongside one another, it is possible to cover relatively large floor or wall areas or ceilings with the coverings according to the invention.

A method for achieving the object mentioned in the introduction is a method for producing a covering as disclosed herein with a functional body, characterized in that a flowable adhesive is applied to a structured functional body, in which a temperature-control means is integrated, and the covering is deposited on said functional body which has been provided with adhesive. Accordingly, provision is made that, for the production of a covering as disclosed herein with a functional body, a flowable adhesive is applied to a structured functional body, in which a temperature-control means is integrated, and the covering is deposited on said functional body which has been provided with adhesive.

Furthermore, provision can then be made for the covering to be deposited on the top side of the functional body, said top side being provided with adhesive, and on a seal which runs around the functional body, and for the functional body to be rotated together with the covering in order to dry the adhesive, such that the adhesive dries on a bottom side of the covering. The rotation of the composite, consisting of the covering and the functional body, causes the adhesive to come into contact with the bottom side of the covering which is to be bonded, as a result of which a fixed connection is formed between the aforementioned constituent parts. As a result of the rotation, the adhesive is distributed over the entire bottom side of the covering, as a result of which the formation of insulating air bubbles is in particular prevented. The liquid adhesive runs in particular up to the peripheral regions of the functional body, which are preferably enclosed by a sealing means. This method according to the invention for producing a covering can be carried out both manually for individually fabricated coverings and by machine or industrially in large quantities for coverings of at least virtually identical design.

### BRIEF DESCRIPTION OF THE DRAWINGS

A preferred exemplary embodiment of the present invention is described in more detail below with reference to the drawing, in which:

FIG. 1 shows a view of a top side of a functional body;

FIG. 2 shows a section through a side region of the functional body as per FIG. 1;

FIG. 3 shows a view of a bottom side of the functional body;

FIG. 4 shows a view of a covering with a functional body on two raised floor supports; and

FIG. 5 shows a further exemplary embodiment of a functional body with a covering.

### DETAILED DESCRIPTION OF PREFERRED EMBODIMENTS

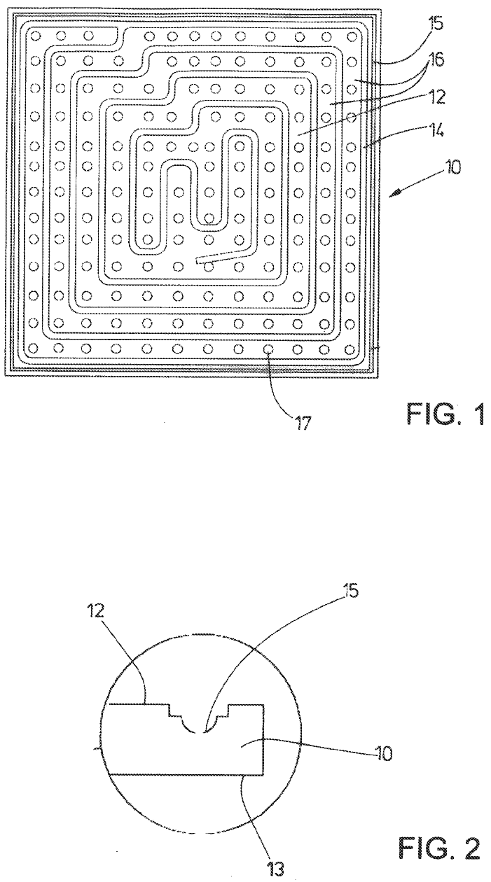

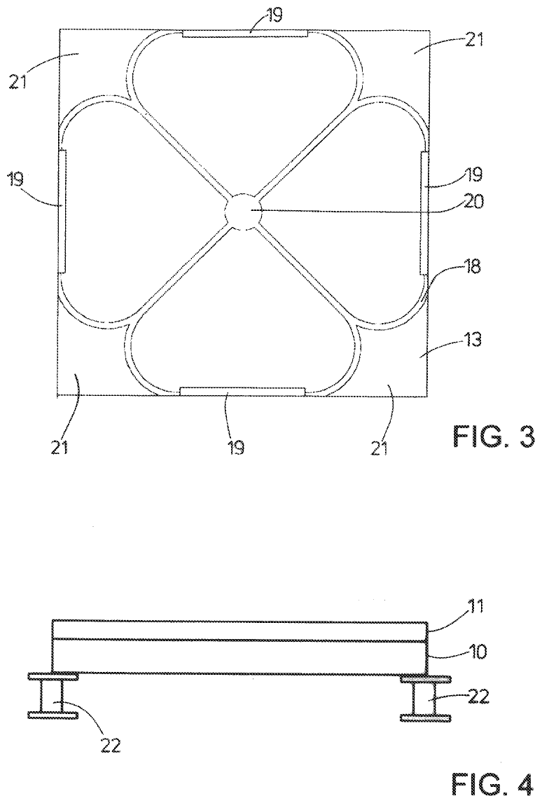

FIG. 1 illustrates an exemplary embodiment of a functional body 10. Said functional body 10 can be assigned to virtually any desired covering 11. Said covering may be a floor covering or a wall covering or a cover element, such as, for example, glazed tiles, tiles, panels or the like. A feature of the functional body 10 is that its size and its shape are at least virtually identical to a size and a shape of the covering or of the tile or of the glazed tile. However, said functional body can also be smaller, such that a plurality of functional bodies 10 are assigned to one covering. In a deviation from the square shape illustrated in FIG. 1, the functional body 10 can also have another shape.

The square functional body 10 has a top side 12 and a bottom side 13. While the bottom side 13 of the functional body 10 can be deposited on a substrate, the top side 12 can be joined together with the covering 11. In general, the functional body 10 is connected to the covering by means of an adhesive. In this case, the functional body can be used as a heat-insulating means for the covering 11. In particular, the choice of material for the functional body 10 provides good thermal insulation. The material provided is thus, for example, polystyrene, foam, plastic, wood fibers, stone wool, glass wool or mineral wool, vacuum insulation panels or the like. The functional body 10 extends at least virtually over the total area of the covering 11 so that the covering 11 is thermally insulated in a uniform manner.

The present invention also provides that a temperature-control means can be assigned to the top side 12. In this case, said means may for example be a heating wire which is laid in a winding or meandering manner on the top side 12 and specifically in such a way that the entire top side 12 is covered in a thermally uniform manner. This arrangement of the heating wire on the top side 12 likewise makes it possible for the heat energy to be transferred homogeneously to the covering 11. If the heating wire is laid on the top side 12 of the functional body 10, the adhesive is applied between the wires on said top side 12, and therefore the heating wire is enclosed in a sandwich-like manner between the covering 11 and the functional body 10.

The exemplary embodiment of a functional body 10 illustrated in FIG. 1 has a winding channel 14. Said channel 14 is used to integrate the heating wire in the functional body 10, specifically in such a way that said wire still lies in the region of the top side 12. During the adhesive bonding of the functional body 10 to the covering 11, the channel 14 is likewise filled with adhesive in order to obtain uniform heating of the covering 11. In addition to the winding channel illustrated here, it is also conceivable for a meandering channel, a honeycomb structure or a profiling with a waffle structure to be arranged in the top side 12. In all of the exemplary embodiments, the temperature-control means or the heating wire is integrated in the pattern or the structure and the resulting intermediate spaces are filled with adhesive.

In the exemplary embodiment of the functional body 10 illustrated in FIG. 1, an encircling groove 15 is assigned to a side region of the top side 12. Said groove 15 or depression, which is illustrated in cross section in FIG. 2, is used to the effect that the functional body 10 can be fixedly connected to the covering 11 in an areal or uniform manner. In particular during the adhesive bonding operation, the groove 15 can be filled with adhesive, thus guaranteeing that at least the encircling side region of the functional body 10 is adhesively bonded to a bottom side of the covering 11.

The top side 12 has protruding webs 16 between the channels 14, said webs being used, on the one hand, as an adhesive contact area and, on the other hand, for stabilization. Further elements 17 can be provided on said webs 16, said elements being configured for example in the form of protruding nubs which are used as adhesive contact areas. The elements 17 can also be configured in the form of recesses in order to receive a greater amount of adhesive, which is used for making contact with the covering 11.

The depth or milling depth of the groove 15 can be 1 mm to 5 mm, preferably 2 mm. It is necessary for the depth of the channel 14 to be dimensioned in such a way that the heating wire to be inserted can be arranged at least virtually completely in the channel. A preferred depth or milling depth is 2 mm to 6 mm, preferably 5 mm. If the elements 17 are configured in the form of protruding nubs, said nubs project in particular 2 mm to 5 mm, preferably 3 mm, beyond the webs 16.

A channel 18 is likewise arranged on the bottom side 13 of the functional body 10. Said channel is used to stow connections or cables of the heating wires which lie on the bottom side 13. It is in particular possible for extension cables or connecting elements to be stowed in the channel 18 or in the cutouts 19. Said cutouts 19 are preferably assigned only to the bottom side 13, in order to keep the contact area between the bottom side 13 and the covering 11 to a maximum. As a result of this shape of the functional bodies 10, it is possible for a multiplicity of identical functional bodies 10 to be joined together at a respective covering 11, specifically without significant free spaces arising between the functional bodies 10 or the coverings 11. Provision can also be made for further plug-in connections or control elements for control of the temperature-control means to be able to be positioned in a central aperture 20, which is connected to the channel 18. The channel 18 which is arranged on the bottom side 13 can also be provided with an adhesive in order to hold the heating wire in place.

According to the invention, a reinforcement which is not visible here can be integrated in the corner regions 21 of the functional body 10. Said reinforcement is positioned in an aperture which preferably extends from the top side 12 as far as the bottom side 13. A moldable substance such as, for example, mortar or resin is suitable as the material. In this case, the reinforcements are to be positioned or formed in such a way that they occupy as small a region as possible of the area of the top side 12. Only in this way is it possible to realize a homogeneous distribution of the heating wire on the top side 12.

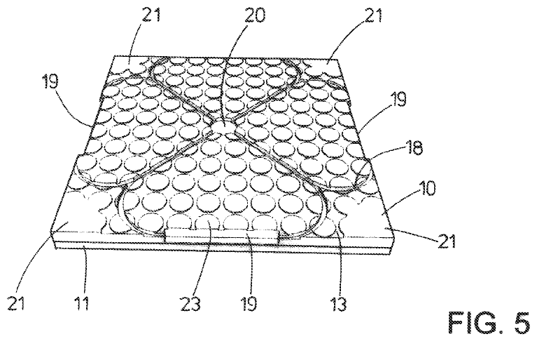

If the bottom side 13 of the functional body 10 is not intended to be deposited directly on a substrate, but rather is to be arranged at a spacing above the substrate by means of raised floor supports 22, the reinforcements in the corner region 21 serve as bearing points for the raised floor supports 22 (FIG. 4). In this case, the raised floor supports 22 are to be assigned to the corner regions 21 in such a way that they can receive a plurality of functional bodies 10 lying next to one another. The reinforcement in the corner regions 21 also makes it possible for the covering 11 to absorb an increased load, specifically without the functional body 10 being deformed in the regions of the reinforcement.

By way of a further reinforcement or further reinforcing elements in the functional body 10, it is possible to stabilize the functional body 10 in such a way that particularly thin coverings 11 or tiles can also be positioned on a substrate by means of raised floor supports 22.

FIG. 5 illustrates a further exemplary embodiment of a functional body 10. In this case, the bottom side 13 has a uniform pattern of nubs 23. Particularly in the case where the bottom side 13 of the functional bodies 10 is set down on a substrate, the nubs 23 can be used to increase the static friction between the bottom side 13 and the substrate. Moisture can also flow away or circulate between the nubs 23 in a more effective manner, and therefore said nubs 23 provide a drainage action. In addition to the shape of the nubs 23 illustrated here, other shapes such as, for example, webs or polygons are also conceivable.

The functional body described here is also characterized by a particularly simple and advantageous production method. In the production method, provision can be made for the functional body 10 per se to be formed in a first step. In this case, a base body is initially formed or molded, in particular by machine or by hand, and/or cut to a size and shape that corresponds to the covering 11, and the channel 14 is optionally milled or cut therein. In a further step, the corner regions 21 can be prepared, in particular cuts can be made, in such a way that the moldable material, in particular a mortar or a resin, can be molded into the empty spaces. In a further step, the temperature-control means or the heating wire can be laid in the channel 14. Thereafter, a corresponding adhesive means can be applied to the entire top side 12 of the functional body 10 and the covering 11 can then be placed on the top side 12. As soon as the adhesive means has at least partially dried, the functional body 10, together with the covering, can be turned over and the connecting or coupling means of the temperature-control means or the cables can be stowed, and possibly fixed, in the channels 18 on the bottom side 13 of the functional body 10. As a result, it is possible for a unit to be produced from a covering with a functional body in a kit-like manner by way of a few steps, wherein the functional body can control the temperature of the covering, provides it with additional stability, and also offers the possibility of positioning even thin coverings on a substrate by means of raised floor supports.

### LIST OF REFERENCE DESIGNATIONS

10 Functional body
11 Covering
12 Top side
13 Bottom side
14 Channel
15 Groove
16 Web
17 Element
18 Channel
19 Cutout
20 Aperture
21 Corner region
22 Raised floor support
23 Nub

1. A functional body (10) for a covering (11), in particular a floor covering or a wall covering or for a cover element, such as, for example, a tile, a glazed tile or a panel, having a bottom side (13) which can be deposited on a substrate, a top side (12) which can be joined together with the covering (11), and a temperature-control means arranged on or in the top side (12).

2. The functional body (10) as claimed in claim 1, wherein a size and a shape of a base area of the functional body (10) at least virtually corresponds to a size and a shape of a base area of the covering (11), or in that a size of the base area of the functional body (10) corresponds to a fraction of the size of the base area of the covering (11).

3. The functional body (10) as claimed in claim 1, wherein the functional body (10) is composed of a heat-insulating material selected from the group consisting of a foam, polystyrene, a plastic, wood fibers, stone wool, glass wool, mineral wool, vacuum insulation panels, and combinations thereof.

4. The functional body (10) as claimed in claim 1, wherein an outer border on the top side (12) of the functional body (10) has a sealing means, namely a sealing surface or a sealing lip, which is preferably self-adhesive and can be brought together with the covering.

5. The functional body (10) as claimed in claim 1, further comprising reinforcing elements and/or reinforcement elements composed of plastic, metal or the like that are integrated, preferably incorporated or molded, in the functional body (10), wherein the reinforcing elements and/or reinforcement elements are arranged in corner regions and/or side regions and/or in a cross-like manner over the total area of the functional body (10) and/or areally over the functional body (10) and wherein at least one region, preferably an edge region and/or a corner region (21), in particular all four corner regions (21) of a rectangular functional body (10), of the functional body (10) has a reinforcement, wherein the reinforcement is a, in particular moldable, material such as, for example, resin, mortar or the like, and said reinforcement extends over a total height of the functional body (10) in the functional body (10).

6. The functional body (10) as claimed in claim 5, wherein the functional body (10) can be set down with a respective reinforcement on a raised floor support (22), wherein a functional body (10) can be set down with four corner regions (21), which have a reinforcement, on four raised floor supports (22) and/or can be set down with a reinforcement of a central region of the functional body (10) on at least one raised floor support (22).

7. The functional body (10) as claimed in claim 1, wherein the temperature-control means is arranged between the covering (11) and the top side (12) of the functional body (10), or in that the temperature-control means is integrated in a top side (12) of the functional body (10), wherein the top side (12) of the functional body (10) is adhesively bonded to the covering (11).

8. The functional body (10) as claimed in claim 1, wherein the top side (12) of the functional body (10) has at least one, in particular winding or meandering, channel (14) or a honeycomb-like pattern or a profiling with a waffle structure in order to receive the temperature-control means, wherein the channel (14) or the pattern extends over the entire top side (12), wherein the temperature-control means is a heating wire, a pipe for guiding a heating means or cooling means, or the like, which is arranged in the channel (18) or the pattern.

9. The functional body (10) as claimed in claim 8, wherein two first ends or connections of the heating wire or of the pipes are led away over a periphery of the functional body (10) and have means, in particular plug-in connectors, clamps, crimp connections, solder connections, valves or the like, for connection to a further cable or to a further pipe, preferably further heating wires or pipes of adjacent functional bodies (10).

10. The functional body (10) as claimed in claim 1, wherein a bottom side (13) of the functional body (10) has at least one, in particular winding or meandering, channel (18) or a honeycomb-like pattern in order to receive cables of the temperature-control means, wherein the bottom side (13) of the functional body (10) has a symmetrical channel structure in order to receive cable portions of identical length, such that plug-in connections of adjacent functional bodies (10) project to the same extent beyond the respective functional body (10).

11. The functional body (10) as claimed in claim 1, wherein side regions of the functional body (10) have cutouts (19) in order to receive means, in particular plug-in connectors, clamps, crimp connections, solder connections, valves or the like, for connection of a plurality of heating wires or pipes of adjacent functional bodies (10).

12. The functional body (10) as claimed in claim 1, wherein the temperature for a covering (11) with a temperature-control means (master) can be set by means of a control unit and coverings (11) (slave) which are also coupled to the covering (11) or to the temperature-control means adapt to said temperature, wherein the temperature of individual coverings (11) or of groups of coverings (11) can be controlled individually by way of the control unit, and/or in that the control unit is connected to at least one sensor means which is integrated in the functional body (10) and/or the covering (11), wherein the temperature of the functional body (10) and/or of the covering (11) can be controlled in dependence on a measurement value of the sensor means, and/or in that the at least one sensor means can be a temperature sensor, a moisture sensor or a pressure sensor, and/or in that further components can be integrated in the functional body (10) and/or in the covering (11), such as, for example, speakers, illuminants, power sockets, network sockets and the like, said components being able to be actuated, in particular individually or in groups, via corresponding lines beneath the covering (11).

13. The functional body (10) as claimed in claim 1, wherein the functional bodies (10) are protected by a metal layer or a plastics layer or a shell, in particular a metal or plastics shell.

14. A covering (11), in particular a floor covering or a wall covering or a cover element, such as, for example, a tile, a glazed tile or a panel, a fiber-cement plate, a gypsum plasterboard or a decoupling membrane, one side of which can be joined together with a functional body (10), the functional body (10) having a bottom side (13) which can be deposited on a substrate, a top side (12) which can be joined together with the covering (11), and a temperature-control means arranged on or in the top side (12).

15. A method for producing a covering (11), in particular a floor covering or a wall covering or a cover element, such as, for example, a tile, a glazed tile or a panel, a fiber-cement plate, a gypsum plasterboard or a decoupling membrane, one side of which can be joined together with a functional body (10), the functional body (10) having a bottom side (13) which can be deposited on a substrate, a top side (12) which can be joined together with the covering (11), and a temperature-control means arranged on or in the top side (12), comprising applying a flowable adhesive to a structured functional body (10), in which the temperature-control means is integrated, and the covering (11) is deposited on said functional body (10) which has been provided with adhesive.

16. The method for producing a covering (11) as claimed in claim 15, wherein the covering (11) is deposited on the top side (12) of the functional body (10), said top side being provided with adhesive, and on a seal which runs around the functional body (10), and the functional body (10) is rotated together with the covering (11) in order to dry the adhesive, such that the adhesive dries on a bottom side of the covering (11).
